(19) United States
(12) Patent Application Publication
(10) Pub. No.: US 2009/0235621 A1
(43) Pub. Date: Sep. 24, 2009

(54) GLUE-ON HORSE BOOT

(75) Inventor: GARETT N. FORD, Tucson, AZ (US)

Correspondence Address: ANTONIO R. DURANDO, 6902 N. TABLE MOUNTAIN ROAD, TUCSON, AZ, 85718-1331, US

(73) Assignee: EASYCARE, INC., Tucson, AZ (US)

(21) Appl. No.: 12/401,107

(22) Filed: Mar. 10, 2009

Related U.S. Application Data
(60) Provisional application No. 61/070,114, filed on Mar. 20, 2008.

(51) Int. Cl. B68C 5/00

(52) U.S. Cl. 54/82

(57) ABSTRACT

A horse boot has an upper that includes substantially independent side walls that may be flexed inward or outward as needed to conform to the shape of the hoof to which the boot is fitted. The upper also includes a short rear lip projecting backward at an approximate 45-degree angle to facilitate entry while still providing a ridge to enclose the back bottom portion of the hoof. The inside of the boot is lined with bonding material along the interior surface of the upper. The boot is fitted to the hoof and held in place while the bonding material hardens, thereby securing the boot to the hoof. The entire fitting process may be carried out in less than two minutes.

### RELATED APPLICATIONS

This application is based on and claims the priority of U.S. Provisional Application No. 61/070,114, filed Mar. 20, 2008.

### BACKGROUND OF THE INVENTION

1. Field of the Invention

The invention relates in general to boots for horses and, in particular, to a boot held In place by bonding the interior surface of the boot to the hoof of the horse.

2. Description of the Prior Art

Horse boots are used to protect the hooves and fetlocks of horses and may be used in lieu of horseshoes. A horse boot typically includes a sole with opposed flat, top and bottom, major surfaces and an upper that projects upward from the top surface of the sole and forms an enclosure for the hoof of the horse. The upper typically extends along the rim of the sole and has a bottom edge secured to the sole. A tongue is usually formed in the front portion of the upper. The top edge of the upper is remote from the sole and is sometime connected to a cuff that can be tightened around the hoof and pastern of the horse.

In the typical arrangement, the upper and the cuff (if present) are spread open in order to place the boot on the hoof of the horse. After spreading open the upper and the cuff, the boot is slid over the hoof and the upper is tightened around the hoof to secure the boot in place. Several means for tightening the upper have been used in the art, such as laces, straps, and cables connected to a buckle or other tensioning device mounted on the tongue. As the buckle is pivoted closed, it pulls on the cable and tightens both front ends of the upper around the hoof.

Such tensioning devices have been improved and perfected to provide variable degrees of tensioning and ranges of adjustment to fit different riding conditions and hoof sizes. However, fitting a boot to a particular hoof remains a challenge because of the variation in the size and shape of horses' hooves. Even among horses wearing the same size boot (which is determined by the size of the footprint of the hoof), the shape of the hoof's top portion varies from horse to horse, requiring different degrees of tension in order to cause the upper to adhere to the hoof's surface and firmly secure the boot on the hoof. Furthermore, tensioning devices are subjected to severe mechanical stresses during use, especially during hard riding conditions, and therefore they tend to brake. When that happens, the only recourse is a replacement boot, which may or may not be available while riding out in the field.

In order to avoid the complications associated with tensioning devices of prior horse boots, in U.S. Pat. No. 4,189,004 Glass describes a simplified configuration of boot that can be affixed simply by screws penetrating the hoof on each side of the lateral walls of the boot. In the form of a slipper with a continuous upper without a rear cup or tongue, the boot is easily put on from the front by slipping it on until the front and side surfaces of the hoof butt against the interior of the boot's upper. The screws are then inserted into the sides of the hoof to secure the boot in place. Foam may be used to seal the edge of the upper around the hoof to keep debris out of the boot.

The screws of the Glass approach provide a simplified and more durable mechanism for securing a horse boot in place; however, it still requires a laborious procedure for putting the boot on and taking it off. In addition, the slipper configuration of the boot allows a perfect fit when the upper matches well the shape of the hoof, but it does not allow the upper to deform to conform to the hoof when the two are not substantially the same, which is a common recurrence even for same size hooves. This drawback is underscored by Glass's use of foam to fill the cavities resulting from the fit.

This invention is directed at providing a solution to these problems. Specifically, the invention is directed at providing a horse boot that is secured to the hoof of the horse only by bonding, without any additional restraining device. The boot is designed for a rapid and durable fit, and for maximum flexibility in conforming to the shape of the hoof.

### SUMMARY OF THE INVENTION

The invention is a boot with an upper that includes substantially independent side portions that may be flexed as needed to conform to the shape of the hoof to which the boot is fitted. The upper also includes a short rear lip projecting backward at an approximate 45-degree angle to facilitate entry while still providing a ridge to but against the back bottom portion of the hoof. The front portion of the upper may consists substantially of a relatively tall, wide tongue to cover the front of the hoof, in which case the upper includes three flexible portions. However, in the preferred embodiment no tongue is present and the upper includes only two side portions separated by a frontal slit. In either case the two side portions of the upper consists of backward sloping walls that are normally bent inward to provide some inward pressure against the sides of the hoof of the horse. All upper constituents are sufficiently resilient to permit bending under hand pressure to fold them to conform to the shape of the hoof. If present, the front tongue is separated by each side wall by a sufficiently deep slit to allow each lateral portion of the upper to move substantially independent of the other, so that maximum conformance to the shape of the hoof may be obtained when the boot is fitted to the horse. If no tongue is present, the same type of slit is used in the middle of the front portion of the upper to form the two separate side walls.

The boot of the invention is designed for bonding to the hoof of the horse. Accordingly, prior to fitting, the inside of the boot is lined with bonding material along the interior surface of the upper, preferably ensuring that no adhesive flows past the perimeter of the juncture of the sole to the upper. The boot is fitted to the hoof of the horse from the front by sliding it into place until the hoof butts firmly against the front of the upper. Because of the shape of the upper, the boot conforms readily to the side walls of the hoof and stays in place while the bonding material is hardening even without pressing against it. The entire fitting process may be carried out in less than two minutes.

The fitting process involves sliding the hoof into the boot from the back. Because the upper side walls are formed to urge closure inward, in some embodiments of the invention this process may be facilitated by scoring the interior of the walls along a desirable folding line. Such a scored groove provides a defined line along which folding may be obtained with less effort, thereby making it easier, when helpful, for a user to enlarge the opening while installing the boot.

The bonding material applied to the interior surface of the upper may cause some glue to spread to the sole and the frog of the hoof, which would be very undesirable. Therefore, though not necessary, an insert attached to the top surface of the sole may be used to protect the frog. Such insert would be shaped substantially as the frog and placed in the boot in substantial alignment with it, so as to prevent spreading of the bonding material toward the center of the sole's top surface.

Additional features and advantages of the invention will be forthcoming from the following detailed description of certain specific embodiments when read in conjunction with the accompanying drawings.

### BRIEF DESCRIPTION OF THE DRAWINGS

FIG. 1 is a perspective view the front-left side of a horse boot according to the invention wherein the upper includes a conventional front tongue.

FIG. 2 is a perspective view the front-left side of a horse boot according to the preferred embodiment of the invention wherein the upper includes two side walls separated by a frontal slit without a tongue.

FIG. 3 is a perspective view of the front of the boot of FIG. 2.

FIG. 4 is a perspective view of the back of the boot of FIG. 2.

FIG. 5 is a perspective view of the left side of the boot of FIG. 2.

FIG. 6 is a perspective rear view of the boot of FIG. 2 showing a protective frog pad mounted on the top surface of the sole of the boot.

FIG. 7 illustrates a bead of bonding material applied to the inner surface of the upper as the initial step of fitting the horse boot.

FIG. 8 illustrates the process of installing the boot on the horse by engaging the front portion of the hoof with the back of the boot.

FIG. 9 illustrates the horse boot of the invention after fitting to the hoof of a horse.

### DETAILED DESCRIPTION OF THE PREFERRED EMBODIMENT

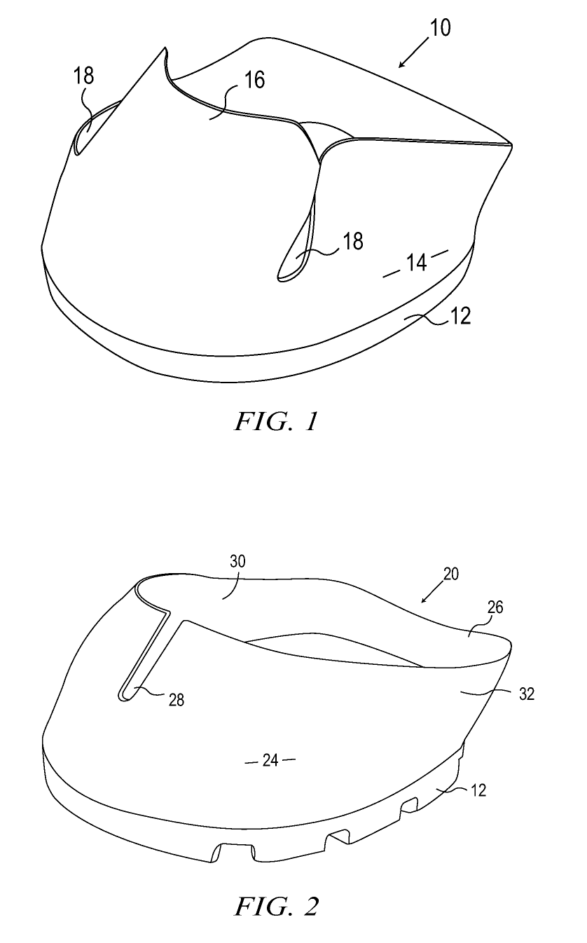

Referring to FIG. 1, a glue-on horse boot 10 according to the invention is illustrated. The shell of the boot consists of a sole 12 and a continuous upper 14 connected at a lower edge to the periphery of the sole 12. The upper 14 may include a front tongue 16 projecting upward and rearward from the front of the sole 12, at an angle designed to conform approximately to the slope of a typical hoof, which is in the 50-70 degree range. The top of the tongue 16 is separated from the rest of the upper by two lateral slits 18 that allow the tongue 16 to resiliently fold forward or backward from its normal position as necessary to conform better to the shape of the hoof wearing the boot without affecting the shape of the rest of the shell.

In the referred embodiment of the invention illustrated in FIG. 2, the glue-on horse boot 20 has a shell with an upper formed without a tongue. Instead, the shell of the boot 20 consists of a continuous upper 24 connected to the periphery of the sole 12 and including a front slit 28 separating respective right and left sides of the upper to allow them to resiliently fold in and out as necessary to conform to the shape of the hoof wearing the boot.

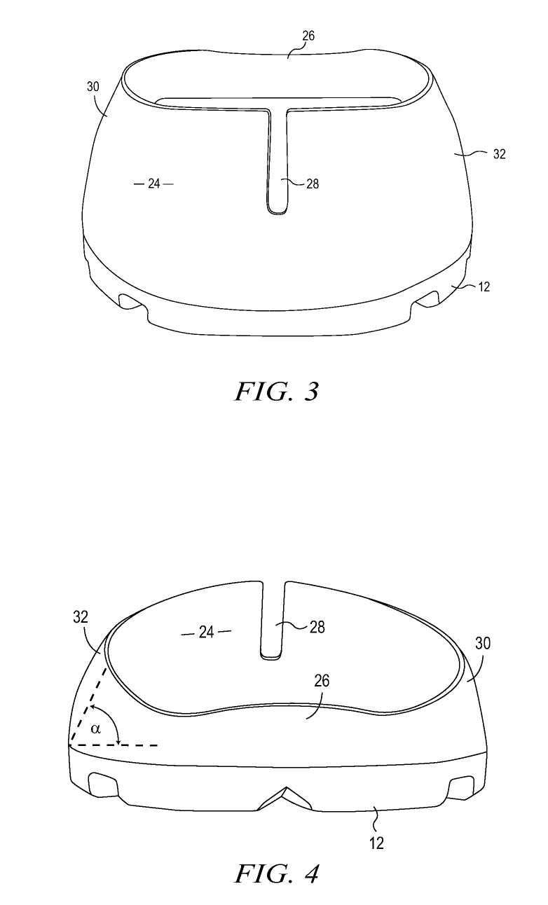

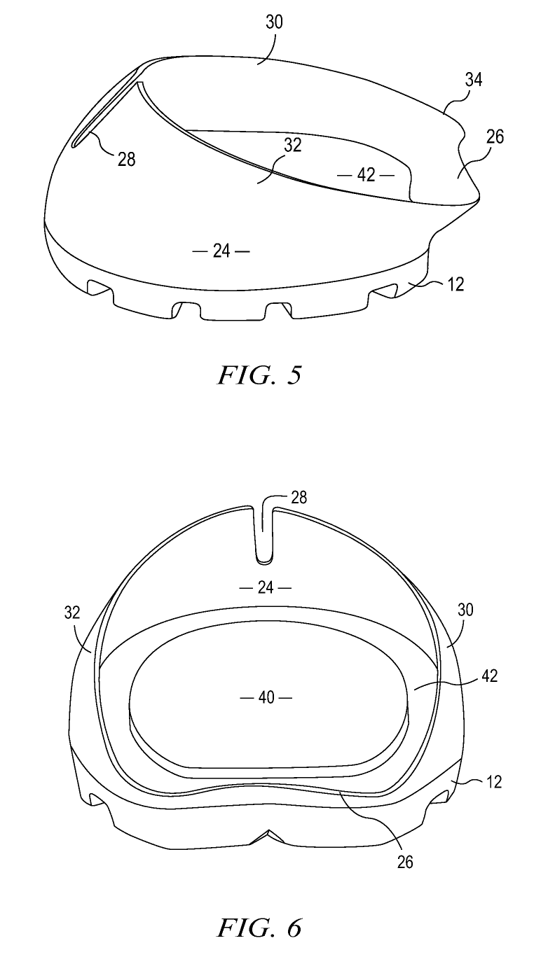

The rest of this disclosure refers to the boot 20 of FIG. 2, but it is understood that the same description would be applicable to the boot 10 of FIG. 1 As mentioned, the upper 24 includes two side walls 30,32 separated by the slit 28. As seen more clearly in FIGS. 3 and 4, the side walls 30,32 are formed so as to be normally folded inward to a degree sufficient to press against the hoof of the horse when the boot is installed. The upper is made of a resilient material, such as polyurethane, so that the side walls (and the tongue 16, in the case of the boot 10 of FIG. 1) can be bent easily to conform to the hoof, as explained above, and also so that the opening defined by the side walls can be expanded to permit insertion of the hoof into the boot 20.

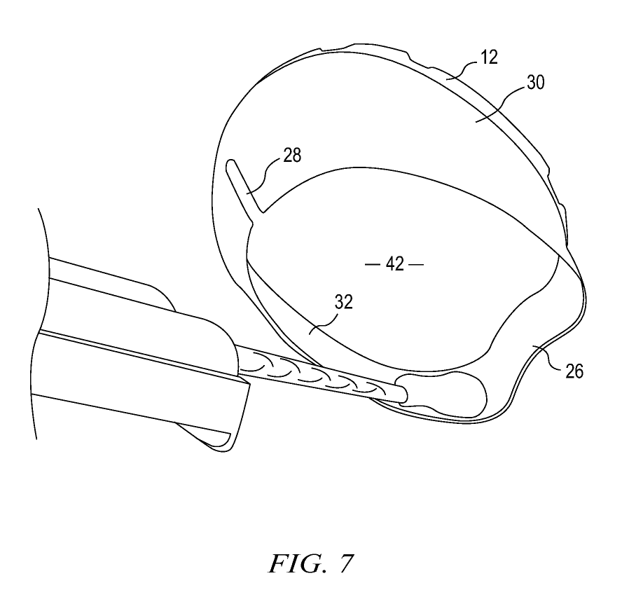

The upper 24 further includes a rear lip 26 that is preferably integral with the side walls 30,32 As seen clearly in FIG. 5, the rear lip 26 is sloped backward at an angle (roughly 45 degrees) deemed sufficiently wide to permit easy entry of the hoof into the boot without bending of the lip. For that same reason, the lip 26 is also shallow, only about one inch deep, which however is sufficient to provide a supporting anchor to the rear bottom of the hoof for a good fit of the boot. The top edges of the side walls 30,32 are preferably sloped downward toward the back to form a continuous top edge 34 with the lip 26. Thus, the top edge 34 of the upper runs continuously from the bottom of the slit 28 through one side wall 30, the rear lip 26, the other side wall 32, and back to the bottom of the slit 28.

Though not critical, the invention may also includes a pad 40 designed to protect the frog of the hoof from glue migrating toward the center of the sole during fitting of the boot. As illustrated in FIG. 6, the pad 40 is simply a layer of soft material, such as EVA (ethylene vinyl acetate), placed between the frog and the top surface 42 of the sole 12. The pad 40 may be glued permanently to the boot or attached by removable means, such as hook-and-loop fastening. The peripheral channel 44 resulting from the presence of the pad 30 on the sole 12 provides a convenient barrier for stopping any excess glue applied to the upper from migrating toward the center during the process of fitting the boot to the hoof of a horse.

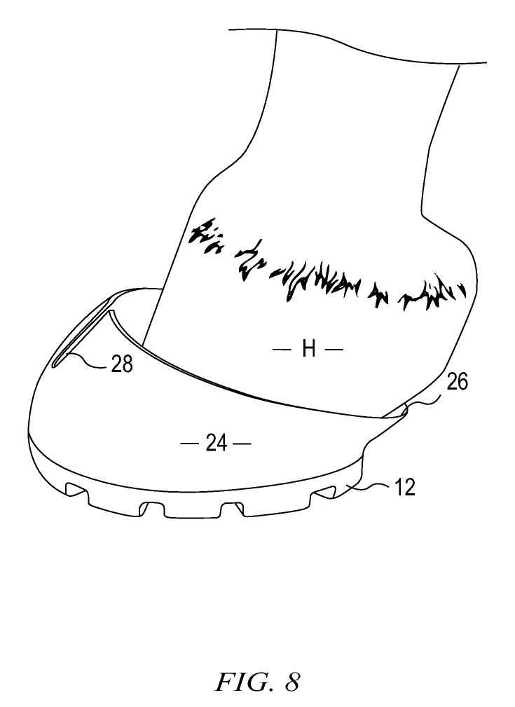

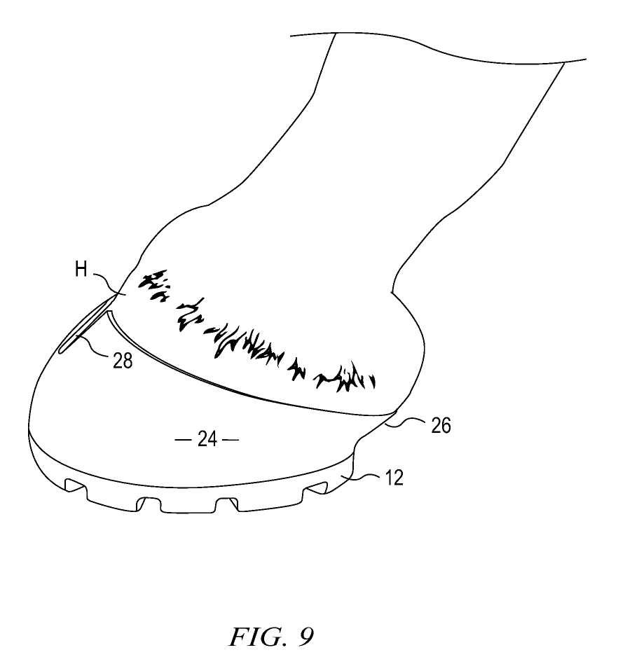

In use, the boot 20 is installed using only glue to secure it to the hoof. After placing an appropriate amount of bonding material on the interior surface of the upper, as illustrated in FIG. 7, the boot is slipped under the hoof H from the front while keeping the side walls 30,32 open. FIG. 8 illustrates this initial step of the process. Though not necessary in the preferred embodiment of FIG. 2, in order to facilitate the opening of the side walls (which are normally bent inward), the interior surfaces of the walls 30,32 may be scored with a groove substantially parallel to the sole that defines a folding line for each side wall. Because of this groove, each side wall may be folded open with less effort than otherwise necessary on account of the inward-folding form of the side walls, thereby making it easier for a user to keep the walls open while fitting the boot to the horse, which has found to be helpful in the embodiment of FIG. 1. The boot is then slipped on completely until the front of the hoof H butts against the front portion of the upper and the bottom of the hoof is contained within and secured firmly by the rear lip 26.

Though typically not necessary, additional bonding material may be applied between the front and sides of the hoof and the upper of the boot in sufficient quantity to assure complete coverage of the abutting surfaces. The boot is then kept firmly in place for the time required for the bonding material to set. Currently available polyurethane glues, such as the product marketed under the mark Sole-Guard by the Vettec Company of Oxnard, Calif., cure in less than 30 seconds. Therefore, the boot need not be held in place long before it is firmly attached to the hoof. The entire fitting process may be accomplished comfortably in less than two minutes. FIG. 10 illustrates the horse boot of the invention after it has been installed on the hoof of a horse.

The side walls 30,32 should be formed with an average angle (measured from a straight line between the interior bottom and top edges of the side wall) that is adequate for pressing naturally inward against the side walls of the hoof when installed. Preferably, an angle of no more than approximately 65 degrees with respect to the sole of the boot is appropriate in order to at least match the slope of the sides of the average hoof so as to press against it to help keep the boot in place even prior to gluing. As illustrated in FIG. 4, such angle α is measured between the sole surface and a straight line connecting the interior bottom edge (secured to the sole) to the top edge of the side wall approximately halfway along the length of the sole. The ideal shape of the upper of the boot of the invention is essentially the same as that of the slipper boot described by the Glass patent above, but with the additional critical features of the slit 28 (or the two slits 18,20 in the case of the boot 10 of FIG. 1) and the inward-folded side walls. These features make it possible to conform the upper to the actual shape of the hoof, thereby making it possible to improve adherence and attach the boot solely with bonding material.

Using the Sole-Guard adhesive, the boot of the invention has been fitted to many horses and used in all cases for periods of several weeks without failure until the glue began to give signs of separating from the hoof. At that point it was easily pried apart by pulling on the various portions of the upper. It appears that the normal aging and cell replacement of the hoof causes the outer layers of the hoof to separate from the bonding material without any damage to the hoof or the boot. In fact, the boot may be reattached simply by applying more glue as explained above for another period of use. This length of maintenance-free use is ideal for recreational riding as well as endurance events during which it is particularly important to be able to ride without boot failures.

While the invention has been shown and described herein with reference to what are believed to be the most practical embodiments, it is recognized that departures can be made within the scope of the invention and, therefore, the invention is not to be limited to the details disclosed herein but is to be accorded the full scope of equivalent articles.

1. A glue-on horse boot comprising:
a shell that includes a sole and an upper, said upper including two side walls folded inward to butt against a hoof of a horse wearing the boot; and
bonding material placed between the upper of the boot and the hoof of the horse for adhering the upper to the hoof of the horse.

2. The horse boot of claim 1, further comprising a pad defining a peripheral channel in said sole.

3. The horse boot of claim 1, wherein each of said side walls is normally folded inward at an angle not greater that 65 degrees with the sole's surface, said angle being measured between the sole surface and a straight line connecting an interior bottom edge to a top edge of the side wall approximately halfway along a length of the sole.

4. The horse boot of claim 3, further comprising a pad defining a peripheral channel in said sole.

5. The horse boot of claim 1, wherein each of said side walls of the upper has a top edge that slopes downward toward a back of the boot to define a rear lip projecting backward.

6. The horse boot of claim 5, further comprising a pad defining a peripheral channel in said sole.

7. The horse boot of claim 1, wherein an interior surface of each of said side walls is scored with a groove substantially parallel to the sole to define a folding line.

8. The horse boot of claim 7, further comprising a pad defining a peripheral channel in said sole.

9. The horse boot of claim 1, wherein each of said side walls is normally folded inward at an angle not greater that 65 degrees with the sole's surface, said angle being measured between the sole surface and a straight line connecting an interior bottom edge to a top edge of the side wall approximately halfway along a length of the sole.

10. A method of fitting a horse boot to a hoof of a horse, comprising the following steps:
providing a boot with a shell that includes a sole and an upper, said upper including two side walls folded inward to butt against a hoof of a horse wearing the boot;
applying bonding material on an interior surface of the upper;
fitting the boot to the hoof of the horse; and
holding the boot in place until the bonding material has cured.

11. The method of claim 10, wherein said boot further comprises a pad defining a peripheral channel in said sole.

12. The method of claim 10, wherein each of said side walls is normally folded inward at an angle not greater that 65 degrees with the sole's surface, said angle being measured between the sole surface and a straight line connecting an interior bottom edge to a top edge of the side wall approximately halfway along a length of the sole.

13. The method of claim 12, wherein said boot further comprises a pad defining a peripheral channel in said sole.

14. The method of claim 10, wherein each of said side walls of the upper has a top edge that slopes downward toward a back of the boot to define a rear lip projecting backward.

15. The method of claim 14, wherein said boot further comprises a pad defining a peripheral channel in said sole.

16. The method of claim 10, wherein an interior surface of each of said side walls is scored with a groove substantially parallel to the sole to define a folding line.

17. The method of claim 16, wherein said boot further comprises a pad defining a peripheral channel in said sole.

18. The method of claim 10, wherein each of said side walls is normally folded inward at an angle not greater that 65 degrees with the sole's surface, said angle being measured between the sole surface and a straight line connecting an interior bottom edge to a top edge of the side wall approximately halfway along a length of the sole.
